(19) United States
(12) Patent Application Publication
(10) Pub. No.: US 2010/0308032 A1
(43) Pub. Date: Dec. 9, 2010

(54) INSULATED HEATING CONTAINER WITH THERMOCHROMATIC INDICATOR

(76) Inventors: Linda GILLILAND, Maitland, FL (US); Mary Downs, Franklin, TN (US)

Correspondence Address: BERENATO & WHITE, LLC, 6550 ROCK SPRING DRIVE, SUITE 240, BETHESDA, MD, 20817, US

(21) Appl. No.: 12/478,211

(22) Filed: Jun. 4, 2009

(51) Int. Cl. F27D 11/00

(52) U.S. Cl. 219/438

(57) ABSTRACT

A container for heating textiles including at least one thermochromatic sensor element incorporated into one of the sidewalls to indicate when the product being warmed inside the container has reached a certain temperature. The container is insulated and constructed of flexible materials so as to be collapsible. One or more heating elements inside the container provide heat for warming the textiles. The container may take many shapes (e.g., rectangular, oval, round) to acconunodate different textiles and other articles within the container, and the container may include a hook to hang the device on a bar.

### BACKGROUND OF THE INVENTION

a) Field of the Invention

The present invention concerns a container for heating textiles. In particular the present invention concerns a so-called “soft-sided” container including a heating element for warming towels, garments, etc.

b) Description of Related Art

It is known to provide an electrically heated container having separate compartments for warm food, cool food, and a beverage, whereby the container is constructed of rigid, i.e. not collapsible, sides with a hinge connecting the cover to the body of the lunch box. Such devices may also include a separate compartment underneath the warm food compartment. These containers may also be formed from a molded plastic electrically heated container. These containers do not include collapsible surfaces.

It is also known to provide a lunch box for keeping its contents cool during hot weather to prevent spoiling of food, and heating its contents if desired.

However, the prior art device(s) do not provide a convenient means for identifying the temperature of the inside of the container using a suitable visual indicator that is easily incorporated into the external surfaces of the container.

### SUMMARY OF THE INVENTION

In many instances it is desirable to have warmed towels (e.g. after bathing) or warmed garments (e.g. when dressing an infant) and/or warmed food items (e.g., bottle(s)), for example, for infants. An objective of the present invention is to provide a flexible, insulated container which includes a heating element for warming textiles such as towels, food items or garments. The container itself may take many shapes and forms (e.g., rectangular, round, etc) and may be deformable to provide a flexible arrangement for use.

To solve the deficiencies in the prior art, the present invention provides a thermochromatic fabric fixed to the container in order to identify when the product in the container is warn. The thermochromatic fabric is visible to the user and is easily incorporated into the sides or top of the container.

These and other benefits of the invention will be apparent from the following description with reference to the attached drawings.

### BRIEF DESCRIPTION OF THE DRAWINGS

FIG. 1 is a front elevation illustrating the present invention.

FIG. 2 is a right-side elevation illustrating the present invention shown in FIG. 1.

FIG. 3 is a back elevation illustrating a modified version of the present invention.

FIG. 4 is a eft-side elevation illustrating the modified version of the present invention shown in FIG. 3.

FIG. 5 is a top view illustrating the modified version of the present invention shown in FIG. 3.

FIG. 6 is a bottom view illustrating an alternate version of the present invention.

FIG. 7 is a perspective view of the present invention illustrating the interior.

FIGS. 8a and 8b provide side views illustrating the invention in various collapsed states.

FIG. 9 is a cross sectional view of the container of FIG. 3 shown along section line IX-IX with a modification to show towel bar hooks.

### DESCRIPTION OF THE PREFERRED EMBODIMENT

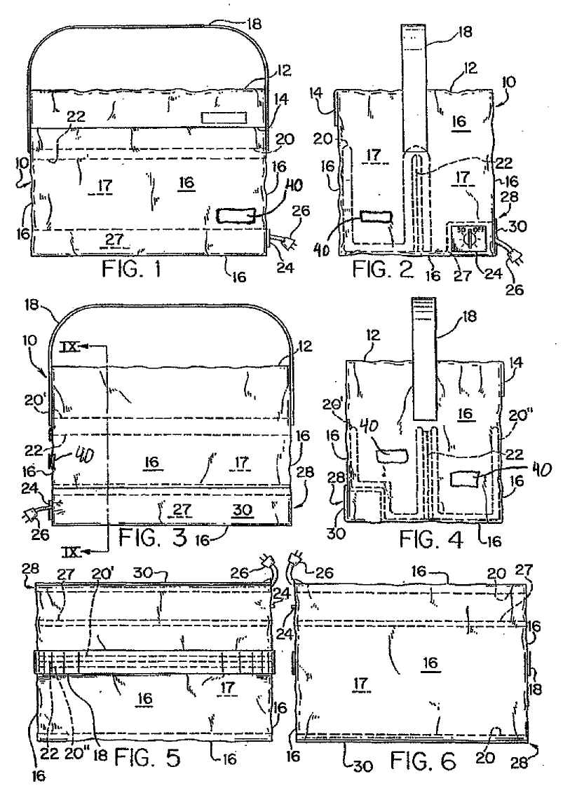

FIGS. 1 and 2 show the present invention wherein a container 10 includes access to the interior of the container 10 through an aperture in the top of the container 10. A first closure 12 covers the aperture and includes a forward facing flap 14 adapted to secure the first closure 12 to one of a plurality of collapsible surfaces 16. A textile (not shown) is placed within, and removed from, a first enclosure 17 within the interior of the container 10 via the aperture. A handle 18 is provided for ease of carrying the container 10.

At least one heating element 20 is located inside the interior and/or the back surface of the container 10 for warming the textile. The heating element 20 is in the form of a flexible sheet covering a majority of at least one surface 16 and/or the first closure 12. In FIGS. 1 and 2, a single heating element 20 is shown covering a majority of both the forward surface 16 and the bottom surface 16.

Notably, a thermochromatic sensor element 40 in the form of a fabric element is incorporated into at least one of the sidewalls 16 in order to identify and indicate when the product inside the container is warm. The thermochromatic sensor fabric element 40 should be located to accurately reflect the warmth of the product inside the container and also located to be easily viewed by the user. The thermochromatic material may pass through the sidwalls or be disposed on the outside surface. The sensor assembly includes a body, temperature sensor or a thermometer element and an adjacent temperature scale. The thermometer element is preferably of the known temperature-sensitive, thermochromatic type which is composed of a multi-layered sheet. Other types of thermometers may be used. For example, a thermometer may be used to sense when the unit is heated to a suitable degree. The scale may be read by reference to the mark indicated on the thermometer element. The invention may also use thermochromic dyes based on mixtures of leuco dyes with suitable other chemicals, displaying a color change (usually between the colorless leuco form and the colored form) in dependence on temperature. Liquid crystals are capable of displaying different colors at different temperatures and may also be used to form the thermochromatic sensor 40. The color change is dependent on selective reflection of certain wavelengths by the crystallic structure of the material, as it changes between the low-temperature crystallic phase, through anisotropic chiral or twisted nematic phase, to the high-temperature isotropic liquid phase.

An optional partition 22 is shown extending upward from the bottom surface 16 so as to partially divide the interior of the container 10. The heating element 20 in FIGS. 1 and 2 is shown extending up one side of the partition 22, over the top of the partition 22, and down the opposite side of the partition 22.

Temperature and/or operating time of the heating element may be regulated by a control switch 24 located on the exterior of the container 10. A power cord 26 extends out of the container 10 and provides electrical energy to the heating element 20 via the control switch 24. The power cord 26 is stored within a second enclosure 27 inside the container 10. A second closure 28 includes a rearward facing flap 30 covering the second enclosure 27 and secured to one of the plurality of collapsible surfaces 16.

FIGS. 3-5 show a modified version of the present invention having two heating elements 20′,20″ separated by the partition 22. All other elements are similar to those described and indicated with respect to FIGS. 1 and 2. It is also envisioned that the arrangement of the heating elements 20′,20″ could divide the interior 17 without a separate partition 22 as described above. The control switch 24 may control both heating elements 20′,20″ or separate controls may be provided for the respective heating elements 20′,20″.

FIG. 6 shows an alternate version of the present invention wherein a single heating element 20 covers the bottom of the container 10 and also extends upward over a majority of two opposed surfaces 16 which are adjacent to the bottom of the container 10. In the alternate version illustrated in FIG. 6, no partition is present to divide the interior 17.

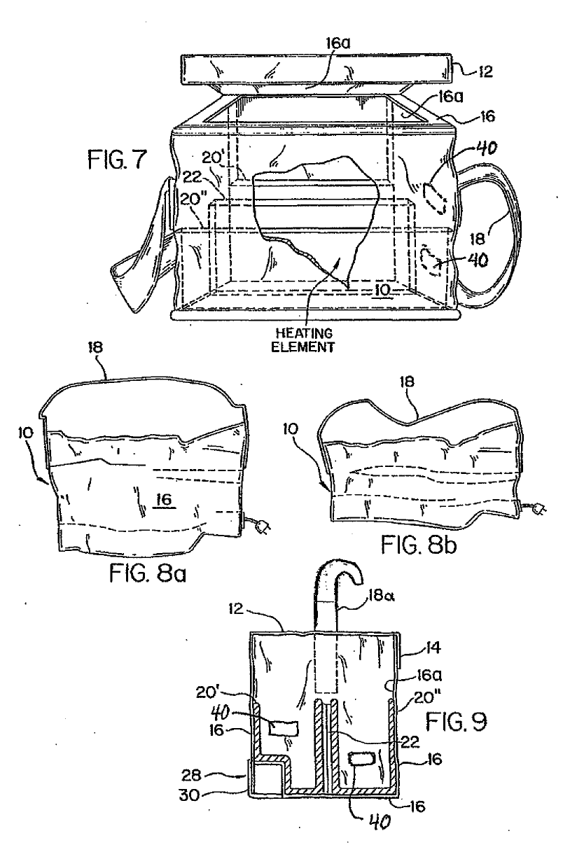

In each version of the present invention, it is envisioned that the plurality of collapsible surfaces 16, as well as the first closure 12 could be insulated so as to avoid the transfer of heat from the interior 17 to outside the container 10. FIGS. 7 and 9 illustrate the insulation 16a provided on the collapsible surfaces 16 and the closure 12. FIGS. 8a and 8b illustrate the container of this invention in various collapsed states.

By virtue of the design of the present invention a large contact surface between the heating element(s) 20, 20″, 20″ and a textile provide relatively uniform heat transfer to the textile. Inasmuch as the partition 22 may only partially divide the interior 17, the textile may be folded over the partition to further enhance heat transfer.

Manufacture of the container 10 is preferably accomplished with flexible sheet goods such as fabric or plastics such that connections between the surfaces 16, as well as the connection between the first and second closures 12, 28 may be similarly effected by sewing or thermoelectric welding, respectively.

FIG. 9 shows an alternate embodiment where the container 10 is provided with towel hooks 18a in place of the handle 18 shown in the other embodiment. Alternatively, a strap or other hanging element(s) may be used in place of the hooks 18a to hang the container on a shower hook, a stroller, or similar article.

While the foregoing embodiments have been shown with reference to specific shapes and details, it will be understood by those of skill in the art that various changes in form and detail may be made therein without departing from the spirit and scope of the instant invention as defined by the appended claims. For example, the container may be rectangular or round or square or may take a deformable shape to provide flexibility during use. Additionally, the thermochromatic sensor may be disposed on a surface of the container or the sensor may be integrated into one side in such a manner to pass from an inside to an outside of the container to indicate the degree of warming of the article in the container. Additionally, the container may utilize a battery pack to provide electric energy for the heating elements etc. Other changes are envisioned with this invention.

What is claimed is:

1. A container for heating textiles, said container comprising:
a first enclosure including first access means for ingress and egress of the textiles to and from an interior of said first enclosure, said first access means including a first closure covering an aperture into said interior, said first enclosure further including a plurality of surfaces surrounding said aperture and defining said interior, said surfaces having an inside face facing said interior, and an exterior face opposite to said interior face;
at least one heating element inside said interior, said heating element being in the form of a separate flexible sheet overlying at least a portion of a first inside face of a first surface, and continuously extending from said first inside face along a substantially perpendicular second inside face of a second surface; and
at least one thermochromatic sensor element for indicating a degree of warmth of a product in said interior of said first enclosure, said thermochromatic sensor element being integrated into at least one of said first closure and said plurality of surfaces.

2. The container according to claim 1, wherein said sensor element passes through at least one inside face or said outside face of said plurality of surfaces.

3. The container according to claim 1, wherein said sensor element is attached to at least one of said inside face, said outside face and said first closure.

4. The container according to claim 1, wherein said container is void of internal partitions.

5. The container according to claim 1, wherein said plurality of surfaces and said first and second surfaces are collapsible.

6. The container according to claim 5, further comprising:
first connection means for attaching said plurality of collapsible surfaces to one another; and,
second connection means for attaching said first closure to one of said plurality of collapsible surfaces;
wherein said first and second connection means are similar.

7. The container according to claim 5, wherein said at least one heating element extends over a majority of at least two of said plurality of collapsible surfaces.

8. The container according to claim 5, wherein said at least one heating element extends over a majority of said first closure and at least one of said plurality of collapsible surfaces.

9. The container according to claim 5, wherein said at least one heating element extends over one of said plurality of collapsible surfaces opposite said aperture, said at least one heating element further extends over two of said plurality of collapsible surfaces adjacent said aperture and opposite one another.

10. The container according to claim 1, further comprising:
partition means for at least partially dividing said interior into a plurality of volumes.

11. The container according to claim 5, farther comprising:
partition means for at least partially dividing said interior into a plurality of volumes, said at least one heating element surrounds said partition means, and said partition means is parallel to said two of said plurality of collapsible surfaces opposite one another.

12. The container according to claim 11, wherein said at least one heating element includes said partition means.

13. The container according to claim 12, wherein said at least one heating means further includes a plurality of spaced apart parallel walls, at least one of said parallel walls is said partition.

14. The container according to claim 1, further comprising:
a second enclosure including second access means for ingress and egress of an electrical power cord for said at least one heating element, said second access means including a second closure for said second enclosure;
wherein said first enclosure is separate and distinct from said second enclosure.

15. The container according to claim 5, further comprising:
insulation substantially surrounding said interior, said plurality of collapsible surfaces and said first closure including said insulation.

16. The container according to claim 1, wherein said separate flexible sheet covers a majority of said first and second faces.

17. The container according to claim 5, wherein said separate flexible sheet further extends along a third collapsible surface which is disposed in parallel relation to said first collapsible surface.

18. A container for heating textiles and other articles, said container comprising:
a first enclosure including first access means for ingress and egress of the articles to and from an interior of said first enclosure, said first access means including at least one closure covering an aperture into said interior, said first enclosure firther including a plurality of surfaces surrounding said aperture and defining said interior taking one of a variety of shapes, said surfaces having an inside face facing said interior, and an exterior face opposite to said interior face;
at least one heating element inside said interior; and
at least one thermochromatic sensor element for indicating a degree of warmth of said article in said interior of said first enclosure, said thermochromatic sensor element being provided on at least one of said first closure and said plurality of surfaces.

19. The container according to claim 18, wherein said heating element defines a separate flexible sheet overlying at least a portion of a first inside face of a first surface, and continuously extending from said first inside face along a substantially perpendicular second inside face of a second surface.

20. The container according to claim 18, wherein said sensor element passes through at least one inside face or said outside face of said plurality of surfaces.
